(19) United States
(12) Patent Application Publication
(10) Pub. No.: US 2007/0023507 A1
(43) Pub. Date: Feb. 1, 2007

(54) Contact data structure and management

(75) Inventors: Bryan T. Starbuck, Redmond, WA (US); Jeffrey J. Wall, Sammamish, WA (US); Mark D. Coburn, Sammamish, WA (US); Alexander J. Castro, Bellevue, WA (US); Stephen Lardieri, Bellevue, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/190,507

(22) Filed: Jul. 26, 2005

(51) Int. Cl. G06K 5/00

(52) U.S. Cl. 235/382

(57) ABSTRACT

Contact data is modified by first identifying contact data associated with a particular contact entry. A file containing the identified contact data is locked and at least one value contained in the contact data is modified. A version stamp associated with the modified value is stored in the file. Additionally, a time stamp associated with the modified value is stored in the file. The file containing the identified contact data is then unlocked.

### BACKGROUND

Users exchange contact data (or contact information) between various devices, such as computers, personal digital assistants (PDAs), personal information managers (PIMs), cellular phones, and the like. Contact data includes, for example, name, address, phone number, and email address. The contact data may be represented in a particular format that is understood by both devices involved in the exchange of data. One such format is the “vCard” format. When users exchange formatted contact data between devices or applications, the contact data is automatically entered into the devices or applications.

Existing contact information data formats have fixed data storage formats that support certain functions. For example, existing data formats define a listing of property-value pairs, such as a “first name” property and an associated first name (e.g., “Robert”) of the contact. These existing contact information data formats are not typically extensible to support additional or enhanced contact data. Thus, devices and application programs are restricted by these predefined data formats.

Therefore, it would be beneficial to provide a flexible contact data structure and management system that may be customized by users or developers.

### SUMMARY

A contact data structure and associated contact data management system are described herein. Contact data is modified by identifying contact data associated with a particular contact entry. A file containing the identified contact data is locked to prevent others from modifying the contact data at the same time. At least one value contained in the contact data is modified. A version stamp associated with the modified value is stored in the file. Additionally, a time stamp associated with the modified value is stored in the file. The file is then unlocked to allow others to modify the contact data.

### BRIEF DESCRIPTION OF THE DRAWINGS

The same numbers are used throughout the drawings to reference like features.

FIG. 1 is a illustrates various components that resolve conflicts in contact data received from multiple devices.

FIG. 2 is a flow diagram illustrating an example process for resolving conflicts in contact data received from multiple devices.

FIG. 3 illustrates an example general computer environment, which can be used to implement the techniques described herein.

### DETAILED DESCRIPTION

The systems and methods described herein provide a contact data structure and an associated contact data management system. The contact data structure stores contact data in a hierarchical manner that permits customization by users and/or developers. For example, the contact data structure supports international customization, permits multiple values associated with a particular property, and supports the use of a time stamp and a version stamp associated with each changed contact data value. The described contact data structure maintains each contact as a separate file, which contains the contact properties. Separate directories are used for storing public and private contact files.

In a particular implementation, each contact is maintained as a separate XML (extensible markup language) file that is handled by the OS (operating system) file system. Although each contact is a separate XML file, the contact data is presented to the user in the form of a typical address book or other familiar graphical layout. Additionally, the systems and methods described herein can receive contact data in a different format (such as the vCard format) and convert the received contact data to the format described below in which each contact is maintained as a separate XML file and handled by the OS file system. After the contact data is converted, the user or developer can take advantage of the customization features offered by the new data format. Although particular contact data structures and file formats (e.g., XML) are discussed herein, alternate embodiments may include different data structures, different data handling procedures, and the like.

Contact File Format

Contact data for each contact is stored in an XML file that can be handled or managed, for example, by the OS file system. XML files containing contact data can be exchanged with other devices or applications, thereby exchanging contact data between devices or applications. The XML data discussed below may be contained in a single XML file associated with a particular contact.

In a particular embodiment, the directory structure that stores the various XML files is the system address book. Each XML file is a contact in the address book. The directory structure includes both public directories and private directories to preserve the security of sensitive data. When a particular file is being updated or modified, it's data is locked to prevent another person or application from updating or modifying the same data. In this embodiment, the file locking is handled by the OS file system, since the OS file system manages the XML files that contain the contact information. This embodiment minimizes the amount of data that is locked by locking the XML file being updated rather than locking all XML files (or locking a single file that contains all contact data).

Each XML file has a base schema that supports basic contact data. Additionally, each XML file may have a custom schema that uses XML namespaces for each custom property used by third party software. These XML namespaces for custom properties typically contain the name of the third party such that multiple third parties can use properties with the same name. The following example shows three different companies using the same property (SYNCDATE): acme:SYNCDATE, badger:SYNCDATE, and bobco:SYNCDATE. Additional examples are discussed below.

The following XML data corresponds to example contact data converted from another data storage format.

```
    <BDAY> 1972-01-23T23:10:00Z </BDAY>
    <TITLE> Development Lead </TITLE>
    <ROLE> Programmer </ROLE>
    <NICKNAME> Trouble </NICKNAME>
    <MAILER VER=“3” MOD=“0F10D2B2C94E748A”> Microsoft
Outlook Express 6.00.5001.0 </MAILER>
    <TZ> -08:00; PST; Pacific Time (US & Canada); Tijuana </TZ>
    <GEO> 37.386013;-122.082932</GEO>
```

In the above example, BDAY identifies the contact's birthday, TITLE identifies the contact's job title, ROLE identifies the contact's job role, NICKNAME identifies the contact's nickname, MAILER identifies the contact's email application version, TZ identifies the contact's time zone, and GEO identifies the contact's geographic location in terms of latitude and longitude.

The following XML data identifies revision information associated with the contact data.

```
  <REV>
    <CREATIONDATE> 2005-04-02T01:55:23.91350Z
</CREATIONDATE>
    <MODIFICATIONDATE VER=“24”> 2005-04-02T01:55:23.91350Z
</MODIFICATIONDATE>
    <acme:SYNCDATE>1FCB85F658228C5B4</acme:SYNCDATE>
  </REV>
```

In the above example, CREATIONDATE identifies the initial creation date (and time) of the contact data, MODIFICATIONDATE identifies the date (and time) of the last modification to the contact data, and acme:SYNCDATE is a custom extension used by an application or device available from a company “acme”. The term “acme” is used in conjunction with SYNCDATE to allow other companies to use the same SYNCDATE identifier. For example, a company “betarun” would use “betarun:SYNCDATE”. Although particular date/time formats are disclosed herein, alternate embodiments may use different date/time formats.

The following XML data identifies a unique identifier associated with the contact data.

```
  <UIDS>
    <UID>28CF6805-821F-9788-4280-A1F089D0B4B5</UID>
    <CONTACTLOCALID>1FF0B4B5-089D-4288-9780-
A18058228CF6</CONTACTLOCALID>
    <acme:RECORDID>1FF0B480A1F658228CB5</acme:RECORDID>
  </UIDS>
```

In the above example, UID identifies a unique identifier that distinguishes the current contact data file from all other contact data files, and CONTACTLOCALID identifies a local computer that issued (or generated) the contact data and acme:RECORDID is a custom extension used by the acme company.

The UID associated with contact data is bound to that particular contact data. Thus, if the file name that stores the contact data is renamed, moved to another directory, or otherwise modified, the UID is unchanged and will identify the correct contact data in the modified file.

The following XML data identifies various name information associated with the contact data.

```
  <NAMES>
    <NAME>
    <FN VER=“3” MOD=“0F10D2B2C94E748A-2B0C9D2”>John T.
Doe</FN>
    <N>
      <FAMILY VER=“2” MOD=“2B27481B0C0A0FDEC-2949D2”>
Doe </FAMILY>
      <GIVEN> John </GIVEN>
      <OTHER> Thomas </OTHER>
      <PREFIX> Mr </PREFIX>
      <INITIALS> JTD </INITIALS>
    </N>
    </NAME>
  </NAMES>
```

In the above example, NAME identifies a particular name associated with the contact, FN identifies a full name (which may include a middle name or middle initial), FAMILY identifies a family (or last) name, GIVEN identifies a given (or first) name, OTHER identifies a middle or other name, PREFIX identifies Mr, Mrs, Ms, etc., and INITIALS identify the contact's initials. In the above example, MOD refers to a modification date/time (e.g., the date/time the FN property was last modified and the date/time the FAMILY property was last modified). Although only one NAME is shown in the above example, alternate embodiments may include multiple NAMEs for a particular contact.

The following XML data identifies various phone numbers associated with the contact data.

```
    <PHONENUMBERS>
      <PHONENUMBER>
      <TEL VER=“4” MOD=“8C10A294E02B74FD-68D2B13EF”
UID=“2b+AS92M0-1aZ9x-1ad9z+”>
        <VALUE VER=“2” MOD=“0F10D2B2C94E748A”> +61 7 555
5534 </VALUE>
        <TYPE>cell </TYPE>
        <TYPE>voice </TYPE>
        <TYPE>pref</TYPE>
        <TYPE>msg</TYPE>
      </TEL>
      </PHONENUMBER>
      <PHONENUMBER>
      <TEL UID=“-6POm8W+MhD+U3e9x-1ZgK”>
        <VALUE> +61 7 555 5555 </VALUE>
        <TYPE>work</TYPE>
        <TYPE>voice</TYPE>
        <TYPE>msg</TYPE>
      </TEL>
      </PHONENUMBER>
      <PHONENUMBER>
      <TEL UID=“aZ0-1K32b+AS924h32M9zd”>
        <VALUE> +61 7 555 5512 </VALUE>
        <TYPE>home</TYPE>
        <TYPE>voice</TYPE>
      </TEL>
      </PHONENUMBER>
    </PHONENUMBERS>
```

In the above example, a PHONENUMBER property is used three times to identify three different phone numbers associated with the contact. Thus, a hierarchy of phone numbers having a particular order is defined. In this example, the first phone number is a cell phone number, the second phone number is a work phone number, and the third phone number is a home phone number. This ordering of the telephone numbers may indicate a preferred order for attempting to call the contact (call cell phone first, then call work number, and finally call the home number).

Additionally, one or more labels can be added to contact data to include metadata about the contact data. For example, such labels may identify preferred phone numbers, personal phone numbers, business phone numbers, mobile phone numbers, pager numbers, fax numbers, and the like. The labels may indicate, for example, the capabilities and/or user preferences regarding various phone numbers. This type of label is not limited to use with phone number data. Labels are also useful with other types of contact data, such as mailing addresses, email addresses, URLs, and the like.

The following XML data identifies various email addresses associated with the contact data.

```
<EMAILADDRESSES>
  <EMAILADDRESS UID=“2b+AS92M0-1aZ9x-1ad9z+”>
    <EMAIL>
      <VALUE>JohnD@workdomain.com</VALUE>
      <TYPE>internet</TYPE>
      <TYPE>pref</TYPE>
    </EMAIL>
  </EMAILADDRESS>
  <EMAILADDRESS UID=“-6POm8W+MhD+U3e9x-1ZgK”>
    <EMAIL>
      <VALUE>JDoe@homedomain.com</VALUE>
      <TYPE>internet</TYPE>
    </EMAIL>
  </EMAILADDRESS>
</EMAILADDRESSES>
```

In the above example, two different email addresses are identified, such as a work email address and a home (or personal) email address.

The following XML data identifies various postal addresses associated with the contact data.

```
  <ADDRESSES>
    <ADDRESS UID=“aZ0-1K32b+AS924h32M9zd”>
      <ADR>
      <STREET> One Acme Way </STREET>
      <EXTADD VER=“2” MOD=“0C0A0FDE482B271BC-2949D2”>
Attn: John Doe, MS-41 </EXTADD>
      <LOCALITY> Redmond </LOCALITY>
      <REGION> WA </REGION>
      <PCODE> 98052 </PCODE>
      <COUNTRY> U.S.A. </COUNTRY>
      <OFFICE> B-41 </OFFICE>
      <TYPE>pref</TYPE>
      <TYPE>work</TYPE>
      <TYPE>intl</TYPE>
      <TYPE>postal</TYPE>
      <TYPE>parsel</TYPE>
      <TYPE>dom</TYPE>
      </ADR>
      <LABEL PARSETYPE=“Literal”>
      Acme Corp.<br/>
      One Acme Way<br/>
      Attn: John Doe<br/>
        MS-41<br/>
      Redmond, WA 98052<br/>
      U.S.A.
      </LABEL>
    </ADDRESS>
    <ADDRESS UID=“4h30-1ZgKK3h32M9zd-6PO”>
      <ADR>
      <STREET> 123 Main Street </STREET>
      <POBOX> 98765 </POBOX>
      <LOCALITY> Redmond </LOCALITY>
      <REGION> WA </REGION>
      <PCODE> 98052 </PCODE>
      <COUNTRY> U.S.A. </COUNTRY>
      <TYPE>home</TYPE>
      <TYPE>dom</TYPE>
      <TYPE>intl</TYPE>
      <TYPE>postal</TYPE>
      <TYPE>parsel</TYPE>
      </ADR>
      <LABEL PARSETYPE=“Literal”>
      123 Main Street<br/>
        PO Box. 98765<br/>
      Redmond, WA 98052<br/>
      U.S.A
      </LABEL>
    </ADDRESS>
  </ADDRESSES>
```

In the above example, two different postal mailing addresses are identified, such as a work mailing address and a home (or personal) mailing address.

The following XML data identifies a logo. If multiple contacts from different companies or organizations are displayed simultaneously, displaying the company logo provides additional information to the user and may allow the user to identify the desired contact faster.

```
  <LOGOS>
    <LOGOENTRY>
      <LOGO UID=“aZ0-1K32b+AS924h32M9zd” ENCODING=“b”
TYPE=“image/jpeg”>
MIICajCCAdOgAwIBAgICBEUwDQEEBQAwdzELMAkGA1UEBhMCVVMxLDA
qBgNVBAoTI05ldHNjYXBlIENvbW11bmljYXRpb25z.....W992WW329
      </LOGO>
    </LOGOENTRY>
  </LOGOS>
```

The following XML data identifies various URLs (uniform resource locators) associated with the contact.

```
  <URLS>
    <URLENTRY UID=“aZ0-1K32b+AS924h32M9zd”>
      <URL>
  <VALUE>http://spaces.msn.com/members/JohnDoe/</VALUE>
        <TYPE>PersonalPage</TYPE>
        <TYPE>Pref</TYPE>
      </URL>
      <msExt:X-ALPHA-RSS>
        <msExt:X-ALPHA-INTERNALID> 9678203421 </msExt:X-
ALPHA-INTERNALID>
        <msExt:X-ALPHA-SYNCFREQ> 00:30:00.00s </msExt:X-
ALPHA-SYNCFREQ>
        <msExt:X-ALPHA-HTML> TRUE </msExt:X-ALPHA-HTML>
        <msExt:X-ALPHA-ZONE> Untrusted </msExt:X-ALPHA-
ZONE>
      </msExt:URL>
      </URLENTRY>
      <URLENTRY UID=“-6POm8W+MhD+U3e9x-1ZgK”>
      <URL>
        <VALUE> http://www.microsoft.com </VALUE>
        <TYPE>Company”</TYPE>
      </URL>
    </URLENTRY>
  </URLS>
```

The following XML data identifies various Instant Message (IM) addresses associated with the contact.

```
<IMADDRESSES>
  <IMADDRESSENTRY>
    <IMADDRESS UID=“2b+AS92M0-1aZ9x-1ad9z+”>
      <VALUE>JDoe@homedomain.com</VALUE>
      <PROTOCOL>Domain1</PROTOCOL>
      <TYPE>Pref</TYPE>
    </IMADDRESS>
  </IMADDRESSENTRY>
  <IMADDRESSENTRY UID=“4h30-1ZgKK3h32M9zd-6PO”>
    <IMADDRESS>
      <VALUE> JDoe@im.com </VALUE>
      <PROTOCOL> IM1 </PROTOCOL>
    </IMADDRESS>
  </IMADDRESSENTRY>
</IMADDRESSES>
```

The following XML data identifies various images, such as photos, associated with the contact.

```
    <USERIMAGES>
      <USERIMAGE>
        <PHOTO UID=“-6POm8W+MhD+U3e9x-1ZgK”
ENCODING=“url” TYPE=“image/gif”>
<VALUE>http://storage.acme.com/s1pZ8pl_R1n1zFOVmCCL2hNjjmrPTu31fKD
P_uf0kPfuqkI6uzSEYiYs4nB9xYuHgotKZK7jBU6shwN4JH4xdQXBA/00.jpg?
MdToken=2377115354623337</VALUE>
        </PHOTO>
        <PHOTO UID=“4h30-1ZgKK3h32M9zd-6PO” ENCODING=“b”
TYPE=“image/jpeg”>
          <VALUE>
MIICajCCAdOgAwIBAgICBEUwDQEEBQAwdzELMAkGA1UEBhMCVVMx
LDAqBgNVBAoTI05ldHNjYXBlIENvbW11bmljYXRpb25z.....W992WW329
          </VALUE>
        </PHOTO>
      </USERIMAGE>
    </USERIMAGES>
```

The following XML data identifies various notes related to the contact data.

```
    <NOTES>
      <NOTEENTRY>
        <NOTE VER=“19” MOD=“0F10D2B2C94E748A”>
          <VALUE>Best to call on cell phone after 8pm\nNeed to
get back to him on Monday.</VALUE>
        </NOTE>
      </NOTEENTRY>
    </NOTES>
```

The following XML data identifies various certificates associated with the contact.

```
    <CERTIFICATES>
      <CERTIFICATE>
        <KEY UID=“aZ0-1K32b+AS924h32M9zd” ENCODING=“b”
TYPE=“X509”>
MIICajCCAdOgAwIBAgICBEUwDQEEBQAwdzELMAkGA1UEBhMCVVMx
LDAqBgNVBAoTI05ldHNjYXBlIENvbW11bmljYXRpb25z.....W992WW329
        </KEY>
        <TYPE>smime</TYPE>
      </CERTIFICATE>
    </CERTIFICATES>
```

The following XML data identifies various organizations associated with the contact.

```
    <ORGS>
      <ORG>
        <ORGNAME> Acme Corp. </ORGNAME>
        <ORGUNITS UID=“+2M0EqM1aZ9x-12ad9+ad9z”>
          <ORGUNIT UID=“aZ0-1K32b+AS924h32M9zd”> ASN
</ORGUNIT>
          <ORGUNIT UID=“-6POm8W+MhD+U3e9x-1ZgK”> CSMP
Communications Mgmt </ORGUNIT>
          <ORGUNIT UID=“4h30-1ZgKK3h32M9zd-6PO”> ASN
Communications Client </ORGUNIT>
          <ORGUNIT UID=“2b+AS92M0-1aZ9x-1ad9z+”>
E-mail Client </ORGUNIT>
        </ORGUNITS>
      </ORG>
        <ORG>
        <ORGNAME>United People of America</ORGNAME>
        <ORGUNITS UID=“M9zaZ41K32b+ASh0-9232d”>
          <ORGUNIT UID=“aZ0-1K32b+AS924h32M9zd”>
United People of America </ORGUNIT>
          <ORGUNIT UID=“4h30-1ZgKK3h32M9zd-6PO”>
United People of Lincoln County </ORGUNIT>
          <ORGUNIT UID=“2b+AS92M0-1aZ9x-1ad9z+”>
Redmond Group </ORGUNIT>
        </ORGUNITS>
      </ORG>
      </ORG>
```

The following XML data identifies various categories associated with the contact.

```
<CATEGORIES>
  <CATEGORYENTRY>
    <CATEGORY> SOFTWARE DEVELOPMENT </CATEGORY>
    <CATEGORY> INTERNET </CATEGORY>
    <CATEGORY> OPERATING SYSTEMS </CATEGORY>
  </CATEGORYENTRY>
</CATEGORIES>
```

The following XML data identifies various entries in an address book.

```
    <ADDRESSBOOK>
      <WEDDINGANNIVERSARY> 2005-04-02T01:55:23.91350Z
</WEDDINGANNIVERSARY>
      <HOBBIES> Underwater Basket Weaving, Watching Paint Dry
</HOBBIES>
      <GENDER> MALE </GENDER>
    </ADDRESSBOOK>
```

The following XML data identifies various extensions and customizations used with the contact data.

```
    <msExt:WABCUSTOM>
      <msExt:X-ALPHA-INTERNALID> 9678203421 </msExt:X-
ALPHA-INTERNALID>
      <msExt:X-ALPHA-SYNCFREQ> 00:30:00.00s </msExt:X-
ALPHA-SYNCFREQ>
      <msExt:X-ALPHA-HTML> TRUE </msExt:X-ALPHA-HTML>
      <msExt:X-ALPHA-ZONE> Untrusted
      </msExt:X-ALPHA-ZONE>
    </msExt:WABCUSTOM>
```

The following XML data identifies information used to synchronize the contact data.

```
<SYNCREPLICATORS>
  <SYNCREPLICATOR UID=“M9zaZ41K32b+ASh0-9232d”>
    <MANUFACTURE> Microsoft </MANUFACTURE>
    <PRODUCT> AddressBook </PRODUCT>
    <VERSION> 6.521.013.42 </VERSION>
    ...
  </SYNCREPLICATOR>
  <SYNCREPLICATOR UID=“M9zaZ41K32b+ASh0-9232d”>
    ...
  </SYNCREPLICATOR>
</SYNCREPLICATORS>
```

The following XML data identifies information associated with one or more applications used by the contact.

```
<APPLICATIONS>
  <APP UID=“M9zaZ41K32b+ASh0-9232d”>
    <MANUFACTURE> Microsoft </MANUFACTURE>
    <PRODUCT> Microsoft Money </PRODUCT>
    <VERSION> 9.90.87.81 </VERSION>
    ...
  </APP>
  <APP UID=“M9zaZ41K32b+ASh0-9232d”>
    ...
  </APP>
</APPLICATIONS>
```

The following XML data is typically private data that is not shared with other users or other devices.

```
<ADDRESSBOOK>
  <SENDRICHINFO> TRUE </SENDRICHINFO>
</ADDRESSBOOK>
<SYNCREPLICATORS>
  <SYNCREPLICATOR UID=“M9zaZ41K32b+ASh0-9232d”>
    ...
  </SYNCREPLICATOR>
</SYNCREPLICATORS>
<APPLICATIONS>
  </APP>
  <APP UID=“M9zaZ41K32b+ASh0-9232d”>
    ...
  </APP>
</APPLICATIONS>
<VCARDCHANGES>
  <VCARDCHANGE>
    <APPLICATION> Microsoft Outlook </APPLICATION>
    <APPVERSION> 11.6359.6408 </APPVERSION>
    <TIMEDATE> 2005-12-25T22:03:59.62299Z </TIMEDATE>
    <VERSION> C923107D-4181-4273-A8DD-06067962BB77@12
</VERSION>
  </VCARDCHANGE>
  <VCARDCHANGE>
    <APPLICATION> Microsoft Hotmail Address Sync Replicator
</APPLICATION>
    <APPVERSION> 7.4065.6938 </APPVERSION>
    <TIMEDATE> 2005-12-23T08:42:39.2105Z </TIMEDATE>
    <VERSION> C923107D-4181-4273-A8DD-06067962BB77@11
</VERSION>
  </VCARDCHANGE>
  <VCARDCHANGE>
    <APPLICATION> Microsoft Windows Address Book
</APPLICATION>
    <APPVERSION> 6.00.2900.2180 </APPVERSION>
    <TIMEDATE> 2005-12-21T03:58:24.85217Z </TIMEDATE>
    <VERSION> C923107D-4181-4273-A8DD-06067962BB77@10
</VERSION>
  </VCARDCHANGE>
  <VCARDCHANGE>
    <APPLICATION> Microsoft Mobile Phone Sync Replicator
</APPLICATION>
    <APPVERSION> 7.4065.6938 </APPVERSION>
    <TIMEDATE> 2005-12-03T10:10:08.01378Z </TIMEDATE>
    <VERSION> C923107D-4181-4273-A8DD-06067962BB77@9
</VERSION>
  </VCARDCHANGE>
</VCARDCHANGES>
```

The VCARD CHANGES shown above are used to record the last few changes made to a contact. This creates a record of the last few modifications to a contact, which can be used to identify applications that might be updating contact data incorrectly.

Various rules may be applied to contact data. For example, the contact data structure normally defines a single value or a collection. Alternatives are similar nodes under a collection node. For example, a PHONENUMBER tag indicates a collection entry. Multiple TEL nodes under the PHONENUMBER would indicate alternatives. Default behavior is to use the first alternative value unless the application understands the meaning of alternative values. Writes to alternative sections generally erase the alternatives, unless flags are specified.

ContactLocalID is generally a globally unique value, however its behavior is mostly focused within the domain of the local computer system. This property is not a URI, typically is a UUID (Unique User ID), but is treated by applications as a string. The local operating system contact APIs create and manage the ContactLocalID. Once a contact has been created, the ContactLocalID property should not change. If an application transports a contact file to another computer, the same ContactLocalID should be kept with the contact file. If the same contact file is synchronized across two computers, the contact file will likely have two different ContactLocalIDs.

A local operating system may have a method to logically “combine” two contacts. The process moves the appropriate contact properties from one contact (legacy) to another (master). The legacy contact will then be deleted. The OS Contact APIs typically track the ContactLocalIDs of the legacy and master contact. Future requests to resolve the legacy ContactLocalID can then be mapped to the new master contact.

CREATIONDATE is the creation date of the contact. The VER attribute is the version number of the changes to this field. The version number is valid to the local machine. If a value is missing, the version number is “0”. The MOD attribute is the last modified time/date in FILETIME UTC format. It can be displayed in one of the following two formats:

```
1. “<FILETIME>”
    Sample: MOD=“0F10D2B2C94E748A”
2. “<FILETIME> − RANGE>”
    Sample: MOD=“0F10D2B2C94E748A−2B0C9D2”
```

This format stores the first time <FILETIME> and the end time is <FILETIME>+<RANGE>. Synchronization replicators will use this if they can't detect when the value changed. In this case, <FILETIME> will indicate the last accurate modification date for this property when the local computer is fully synchronized with the remote contact store. The <RANGE> value is the amount of time after the original modification date that a subsequent remote modification was synchronized into the local contact store. If <RANGE> is not specified, then <FILETIME> is the exact time the user modified the value. If <RANGE> is specified, then the exact time the user modified the value is unknown. The computer knows that the user modified the value at a time after <FILETIME> and before <FILETIME>+<RANGE>. This often happens if the user changes the value on a device, such as a cell phone, and the protocol to synchronize with this device does not provide the time the user made the change. The sync replicator will then store the previous sync time (or previous <FILETIME>+<RANGE>) and the current time (i.e., the time the data is synchronized from the device), and store these two values as the beginning and end of the range. When the exact time of the user change is not possible to know, the range of time can still be valuable in resolving conflicts in future synchronizations.

INSTANTMESSAGINGADDRESS is an address for an Instant Message address. IMADDRESS\PROTOCOL is the protocol for this IM address. It can indicate that it supports more than one protocol. Example protocols include MSN (Microsoft Network), AIM (AOL Instant Messenger), SIP, JABBER, and ICQ. CERTIFICATES refer to a SMIME certificate that is used for S/MIME email messages.

UID defines a unique value that can be used across different devices. UID is globally unique, but not necessarily guaranteed by a universal service. Types of URLs include: “PersonalPage” indicates that the web page the user exposes to the outside world to represent themselves, “Pref” indicates a preferred web site, “Company” is the web site for the company that employs the contact, “RSS” is the contact's RSS XML for automated RSS readers, “RSSweb” is a web site that allows reading this contact's RSS blog posts, and “FTP” provides an FTP site for file downloads. In one embodiment, the UID definition is the same as the definition in the vCard specification.

Conflict Resolution

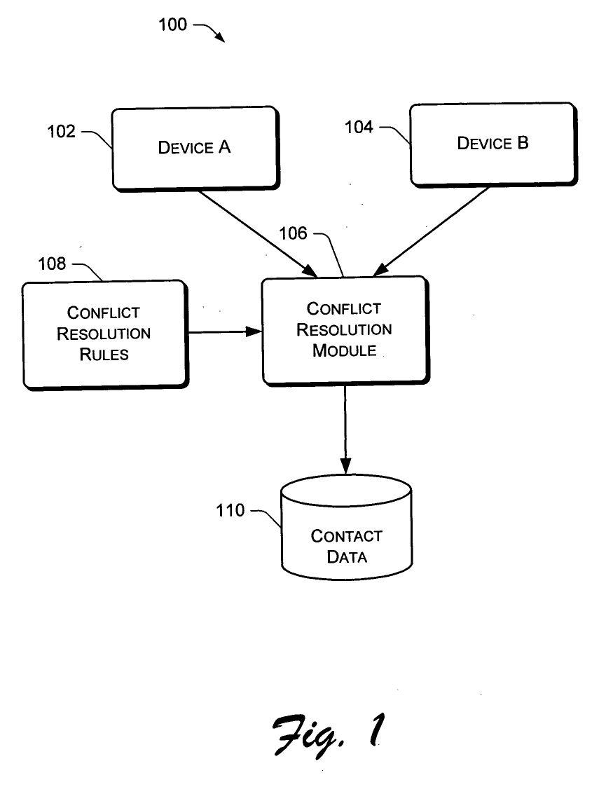

When synchronizing contact data between two or more devices, a conflict may occur if the same data value was changed on two or more devices since the last synchronization operation. FIG. 1 is a illustrates a system 100 that resolves conflicts in contact data received from multiple devices. For example, a contact's work phone number is changed on one device and the same contact's work phone number is changed on another device. In this example, the two changes to the contact's work phone number are not consistent with one another. In this situation, the conflict between the changes to the contact's work phone number must be resolved to complete the synchronization operation.

FIG. 1 illustrates a first device 102 and a second device 104 coupled to a conflict resolution module 106. Conflict resolution module 106 resolves conflicts between two or more devices, such as devices 102 and 104. Conflict resolution module 106 uses one or more conflict resolution rules 108 to resolve conflicts between two or more devices. After the conflict is resolved, conflict resolution module 106 communicates the appropriate data to a contact data store 110. Additionally, conflict resolution module 106 communicates the appropriate data to the two devices 102 and 104 for the two devices to update their own contact data stores (not shown).

In a particular implementation, conflict resolution module 106 is contained in a computing device, device 102 is a PDA, and device 104 is a cellular phone. In this implementation, contact data is stored in all three locations (the computing device, the PDA, and the cellular phone). When synchronizing the contact data, all three devices are checked for changes to the contact data.

The contact data is identified (or located) based on its ContactLocalID. Thus, if the file containing the contact data is renamed, moved, or otherwise changed, the contact data can still be located using the ContactLocalID and is available for synchronization.

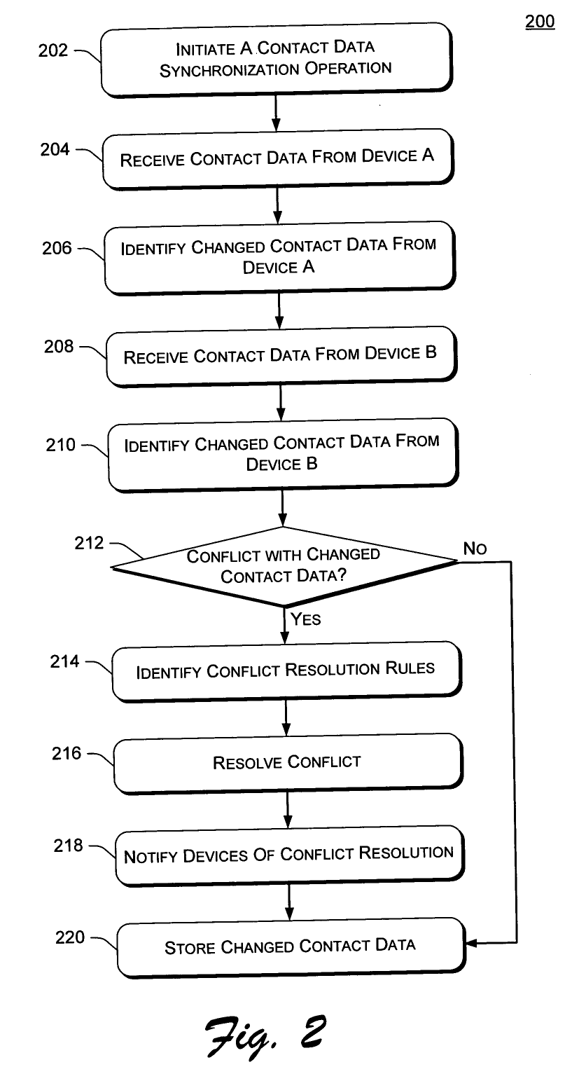

FIG. 2 is a flow diagram illustrating an example process 200 for resolving conflicts in contact data received from multiple devices. The process begins when a contact data synchronization operation is initiated (block 202). The process receives contact data from device A (block 204) and identifies changed contact data received from device A (block 206). Process 200 also receives contact data from device B (block 208) and identifies changed contact data received from device B (block 210).

The process continues by determining whether there is any conflict with the changed contact data (block 212). For example, if the same contact information was changed in device A and device B, but changed in different ways, a conflict exists because the changes are inconsistent with one another. For example, if the contact's state was changed from “CA” to “WA” on device A and changed from “CA” to “MA” on device B, the data cannot be synchronized until the conflict is resolved. Possible resolutions include, leaving the state unchanged as “CA”, changing the state to “WA”, or changing the state to “MA”.

If a conflict exists with the changed contact data, the process identifies is conflict resolution rules (block 214). These rules may be determined by a user, a developer, a network administrator, or other person. The conflict resolution rules define how to resolve various types of conflicts. For example, a rule may specify that the most recently implemented change should control over older changes. The “MOD” parameters discussed herein are useful in determining when a particular change or modification was made to particular data entries in the contact data.

After identifying the conflict resolution rules, the process applies the rules to resolve the conflict (block 216). When the conflict is resolved, all devices involved in the synchronization operation (i.e., all devices that store the same contact data) are notified of the appropriate changes to the contact data (block 218). Finally, the procedure stores the changed contact data (block 220). For example, the changed contact data is stored on a computing device, a PDA, and a cellular phone. If there was no conflict with the changed contact data in block 212, the procedure jumps directly to block 220 to store the changed contact data without the need to resolve any conflicts.

Contact APIs

An example set of contact APIs are provided below.

General Purpose Computer

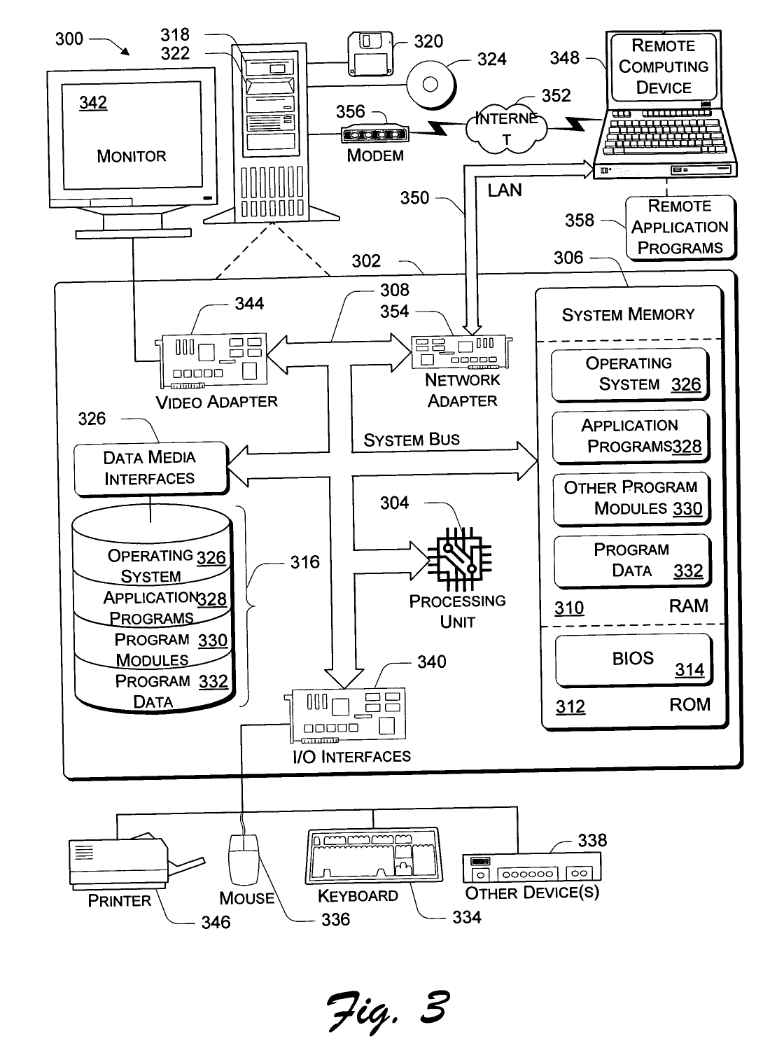

FIG. 3 illustrates an example general computer environment 300, which can be used to implement the techniques described herein. The computer environment 300 is only one example of a computing environment and is not intended to suggest any limitation as to the scope of use or functionality of the computer and network architectures. Neither should the computer environment 300 be interpreted as having any dependency or requirement relating to any one or combination of components illustrated in the example computer environment 300.

Computer environment 300 includes a general-purpose computing device in the form of a computer 302. Computer 302 can be, for example, a desktop computer, a handheld computer, a notebook or laptop computer, a server computer, a game console, and so on. The components of computer 302 can include, but are not limited to, one or more processors or processing units 304, a system memory 306, and a system bus 308 that couples various system components including the processor 304 to the system memory 306.

The system bus 308 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Computer 302 typically includes a variety of computer readable media. Such media can be any available media that is accessible by computer 302 and includes both volatile and non-volatile media, removable and non-removable media.

The system memory 306 includes computer readable media in the form of volatile memory, such as random access memory (RAM) 310, and/or non-volatile memory, such as read only memory (ROM) 312. A basic input/output system (BIOS) 314, containing the basic routines that help to transfer information between elements within computer 302, such as during start-up, is stored in ROM 312. RAM 310 typically contains data and/or program modules that are immediately accessible to and/or presently operated on by the processing unit 304.

Computer 302 may also include other removable/non-removable, volatile/non-volatile computer storage media. By way of example, FIG. 3 illustrates a hard disk drive 316 for reading from and writing to a non-removable, non-volatile magnetic media (not shown), a magnetic disk drive 318 for reading from and writing to a removable, non-volatile magnetic disk 320 (e.g., a “floppy disk”), and an optical disk drive 322 for reading from and/or writing to a removable, non-volatile optical disk 324 such as a CD-ROM, DVD-ROM, or other optical media. The hard disk drive 316, magnetic disk drive 318, and optical disk drive 322 are each connected to the system bus 308 by one or more data media interfaces 326. Alternatively, the hard disk drive 316, magnetic disk drive 318, and optical disk drive 322 can be connected to the system bus 308 by one or more interfaces (not shown).

The disk drives and their associated computer-readable media provide non-volatile storage of computer readable instructions, data structures, program modules, and other data for computer 302. Although the example illustrates a hard disk 316, a removable magnetic disk 320, and a removable optical disk 324, it is to be appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the exemplary computing system and environment.

Any number of program modules can be stored on the hard disk 316, magnetic disk 320, optical disk 324, ROM 312, and/or RAM 310, including by way of example, an operating system 326, one or more application programs 328, other program modules 330, and program data 332. Each of such operating system 326, one or more application programs 328, other program modules 330, and program data 332 (or some combination thereof) may implement all or part of the resident components that support the distributed file system.

A user can enter commands and information into computer 302 via input devices such as a keyboard 334 and a pointing device 336 (e.g., a “mouse”). Other input devices 338 (not shown specifically) may include a microphone, joystick, game pad, satellite dish, serial port, scanner, and/or the like. These and other input devices are connected to the processing unit 304 via input/output interfaces 340 that are coupled to the system bus 308, but may be connected by other interface and bus structures, such as a parallel port, game port, or a universal serial bus (USB).

A monitor 342 or other type of display device can also be connected to the system bus 308 via an interface, such as a video adapter 344. In addition to the monitor 342, other output peripheral devices can include components such as speakers (not shown) and a printer 346 which can be connected to computer 302 via the input/output interfaces 340.

Computer 302 can operate in a networked environment using logical connections to one or more remote computers, such as a remote computing device 348. By way of example, the remote computing device 348 can be a personal computer, portable computer, a server, a router, a network computer, a peer device or other common network node, and the like. The remote computing device 348 is illustrated as a portable computer that can include many or all of the elements and features described herein relative to computer 302.

Logical connections between computer 302 and the remote computer 348 are depicted as a local area network (LAN) 350 and a general wide area network (WAN) 352. Such networking environments are commonplace in offices, enterprise-wide computer networks, intranets, and the Internet.

When implemented in a LAN networking environment, the computer 302 is connected to a local network 350 via a network interface or adapter 354. When implemented in a WAN networking environment, the computer 302 typically includes a modem 356 or other means for establishing communications over the wide network 352. The modem 356, which can be internal or external to computer 302, can be connected to the system bus 308 via the input/output interfaces 340 or other appropriate mechanisms. It is to be appreciated that the illustrated network connections are exemplary and that other means of establishing communication link(s) between the computers 302 and 348 can be employed.

In a networked environment, such as that illustrated with computing environment 300, program modules depicted relative to the computer 302, or portions thereof, may be stored in a remote memory storage device. By way of example, remote application programs 358 reside on a memory device of remote computer 348. For purposes of illustration, application programs and other executable program components such as the operating system are illustrated herein as discrete blocks, although it is recognized that such programs and components reside at various times in different storage components of the computing device 302, and are executed by the data processor(s) of the computer.

Various modules and techniques may be described herein in the general context of computer-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

Alternatively, portions of the framework may be implemented in hardware or a combination of hardware, software, and/or firmware. For example, one or more application specific integrated circuits (ASICs) or programmable logic devices (PLDs) could be designed or programmed to implement one or more portions of the framework.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A method of modifying contact data, the method comprising:
identifying contact data associated with a particular contact entry;
locking a file containing the identified contact data;
modifying at least one value contained in the contact data;
storing a version stamp in the file, wherein the version stamp is associated with the modified value;
storing a time stamp in the file, wherein the time stamp is associated with the modified value; and
unlocking the file containing the identified contact data.

2. A method as recited in claim 1, further comprising:
synchronizing the identified contact data with another device;
determining whether a conflict exists between the identified contact data and contact data on the other device; and
if a conflict exists, resolving the conflict by comparing a time stamp associated with the identified contact data and a time stamp associated with the contact data on the other device.

3. A method as recited in claim 2, wherein resolving the conflict further includes comparing a version stamp associated with the identified contact data and a version stamp associated with the contact data on the other device.

4. A method as recited in claim 2, wherein determining whether a conflict exists includes applying at least one conflict resolution rule associated with the contact data.

5. A method as recited in claim 1, wherein the identified contact data has an associated unique identifier.

6. A method as recited in claim 1, wherein the identified contact data includes an ordered list of values associated with a particular contact parameter.

7. A method as recited in claim 1, wherein the identified contact data includes:
base parameters associated with all contact entries; and
customized parameters defined by a third party and associated with a subset of contact entries.

8. A method as recited in claim 1, wherein the time stamp identifies the last time the associated value was modified.

9. A method as recited in claim 1, further comprising:
assigning a unique identifier to the contact data; and
assigning a file name to the contact data.

10. A method as recited in claim 9, wherein the unique identifier remains unchanged in response to a change in the file name assigned to the contact data.

11. A method as recited in claim 1, further comprising associating a label to at least one value contained in the contact data, wherein the label includes metadata associated with the value.

12. A method comprising:
creating a directory structure including a plurality of public directories and a plurality of private directories, wherein the directory structure represents an address book;
creating a plurality of files such that each of the plurality of files is associated with a particular contact in an address book, wherein each of the plurality of files includes at least one time stamp associated with a contact value, and wherein the time stamp indicates the last time the associated contact value was modified; and
storing the plurality of files in the directory structure.

13. A method as recited in claim 12, wherein each of the plurality of files is an XML file.

14. A method as recited in claim 12, further comprising modifying any of the plurality of files to include additional contact parameters and associated values.

15. A method as recited in claim 12, wherein the plurality of files in the directory structure are managed by an operating system file handler.

16. A method as recited in claim 12, wherein each of the plurality of files in the directory structure has an associated unique identifier.

17. A method as recited in claim 12, wherein each of the plurality of files in the directory structure includes:
an associated unique identifier; and
a file name that is not associated with the unique identifier.

18. An application program interface embodied on one or more computer-readable media, comprising:
a first namespace related to associating contact data with a particular file;
a second namespace related to assigning a unique identifier to the particular file; and
a third namespace related to resolving conflicts in two sets of contact data being synchronized, wherein the third namespace relies on a time stamp associated with each set of contact data and a version stamp associated with each set of contact data.

19. An application program interface as recited in claim 18, further comprising a fourth namespace related to updating contact data in a particular file.

20. An application program interface as recited in claim 18, wherein the third namespace further relies on a plurality of conflict resolution rules to resolve conflicts in two sets of contact data being synchronized.
